(19) United States
(12) Patent Application Publication
(10) Pub. No.: US 2015/0370108 A1
(43) Pub. Date: Dec. 24, 2015

(54) DISPLAY PANEL AND DISPLAY DEVICE

(71) Applicant: BOE TECHNOLOGY GROUP CO., LTD., Beijing (CN)

(72) Inventors: Yanbing WU, Beijing (CN); Yefei DONG, Beijing (CN); Wenbo LI, Beijing (CN)

(21) Appl. No.: 14/576,985

(22) Filed: Dec. 19, 2014

(30) Foreign Application Priority Data
Jun. 18, 2014 (CN) 201410272965.6

(51) Int. Cl. G02F 1/1347; G02F 1/1335; G02F 1/1333; G02C 7/12

(52) U.S. Cl. CPC G02F 1/1347; G02C 7/12; G02F 1/133528; G02F 1/133308; G02F 2001/133531

(57) ABSTRACT

The invention discloses a display panel which includes a liquid crystal cell; a first polarizer, arranged on a light inputting side of the liquid crystal cell; and a second polarizer, a polarization direction of which is perpendicular to a polarization direction of the first polarizer, wherein the second polarizer is detachably arranged on a light outputting side of the liquid crystal cell and is able to cover a valid display region of the display panel. The invention also discloses a display device which includes above display panel and polarized glasses. When there are no confidential files, the second polarizer covers a valid display region of display panel; when there are confidential files to be processed, the second polarizer is removed from the valid display region of display panel. Therefore, it is possible to effectively improve the availability of the display panel and the display device having said display panel.

### CROSS-REFERENCE TO RELATED APPLICATIONS

This application claims the priority of Chinese Patent Application No. 201410272965.6 filed on Jun. 18, 2014 in the Chinese Intellectual Property Office, the disclosure of which is incorporated herein by reference.

### FIELD OF THE INVENTION

The present invention relates to the field of display, and in particular to a display panel and a display device having the display panel.

### BACKGROUND OF THE INVENTION

At present, when there are some confidential files to be processed, it may be desirable to place a display device for displaying files in a secure workspace and only allow an authorized user to enter the secure workspace to use the display device for displaying the confidential files.

In the case that there are no confidential files to be displayed, the display device placed in said secure workspace may be left unused, such that an availability of the display device may be greatly reduced.

### SUMMARY OF THE INVENTION

An objective of the invention is to provide a display panel and a display device having the display panel. By imposing a dual-display function on the display panel provided by the invention, the display device provided by the invention may have a dual-display status with a normal display and a confidential display, so as to realize a high availability and an excellent confidentiality of the display device.

To achieve the above objective, as one aspect of the invention, there is provided a display panel which may include: a liquid crystal cell; a first polarizer arranged on a light inputting side of the liquid crystal cell; and a second polarizer, a polarization direction of which is perpendicular to a polarization direction of the first polarizer, wherein the second polarizer is detachably arranged on a light outputting side of the liquid crystal cell and is able to cover a valid display region of the display panel.

Optionally, said display panel may include a first fixing component arranged on the light outputting side of said liquid crystal cell, said second polarizer being detachably attached to the display panel by said first fixing component.

Optionally, said first fixing component may be arranged on opposite sides of the valid display region of said display panel, slots may be formed in said first fixing component on the opposite sides of the valid display region, and said slots may be opened toward each other such that said slots are able to receive opposite side edges of said second polarizer.

Optionally, one side of said second polarizer may be hinged to a frame of said display panel by a hinge.

Optionally, said second polarizer may be able to be pivoted from a display side of said display panel to a non-display side of said display panel by said hinge.

Optionally, said second polarizer may include a polarization element and a transparent base, said polarization element being attached to said transparent base, a polarization direction of said polarization element being perpendicular to a polarization direction of said first polarizer, and said transparent base being hinged to the frame of said display panel.

Optionally, said second polarizer may include a polarization element and a polarization element frame surrounding an edge of said polarization element, a polarization direction of said polarization element being perpendicular to a polarization direction of said first polarizer, and said polarization element frame being hinged to the frame of said display panel.

Optionally, a second fixing component may be provided on the frame of said display panel, said second fixing component being arranged on a side of the frame opposite the hinge to fix said second polarizer on the light outputting side of said liquid crystal cell.

Optionally, said display panel may include a reel which is arranged on the side of the valid display region of said display panel, said second polarizer being fixedly connected to the reel at one end and being able to be wound around the reel.

As another aspect of the invention, there is provided a display device which may include a display panel and polarized glasses, wherein said display panel is above-discussed display panel as provided by the invention, and said polarized glasses includes a third polarizer, a polarization direction of which is perpendicular to the polarization direction of said first polarizer.

From above, it can be known that a switch of the display panel between a confidential work state and a non-confidential work state can be realized by adjusting a position of the second polarizer. If there are no confidential files to be processed, the second polarizer covers the valid display region of the display panel; on the other hand, if there are confidential files to be processed, the second polarizer is removed from the valid display region of the display panel, such that an operator could not see contents displayed on the display panel unless he or she wears the polarized glasses. Therefore, it is possible to effectively improve the availability of the display panel and the display device having said display panel, and to provide an excellent confidentiality effect.

### BRIEF DESCRIPTION OF THE DRAWINGS

Accompanying drawings are provided for further understanding of the present invention. These drawings constitute a part of the specification and are intended to explain the invention together with the following specific embodiments, but should not be considered as a limitation to the invention. In the drawings:

FIG. 1 is a schematic sectional view of a display panel according to a first embodiment of the invention in a non-confidential work state;

FIG. 2 is a schematic sectional view of a display device according to an embodiment of the invention, wherein the display device includes the display panel as shown in FIG. 1 in a confidential work state;

FIG. 3 is a schematic sectional view of a display panel according to a second embodiment of the invention in a non-confidential work state;

FIG. 4 is a schematic sectional view of a display panel according to a third embodiment of the invention in a non-confidential work state;

FIG. 5 is a schematic sectional view of the display panel as shown in FIG. 4 in a confidential work state;

FIG. 6 is a schematic sectional view of a display panel according to a fourth embodiment of the invention in a non-confidential work state;

FIG. 7 is a schematic sectional view of the display panel as shown in FIG. 6 in a confidential work state;

FIG. 8 is a schematic sectional view of a display panel according to a fifth embodiment of the invention in a non-confidential work state;

FIG. 9 is a schematic sectional view of the display panel as shown in FIG. 8 in a confidential work state.

### DETAILED DESCRIPTION OF THE EMBODIMENTS

Hereafter, specific embodiments of the invention will be described in detail in conjunction with the drawings. It should be understood that the embodiments set forth herein is merely for the purpose of illustration and explanation of the invention and not for limiting the invention.

The display panel according to the embodiment of the invention can have two types of work states, namely a non-confidential work state and a confidential work state. An operator may select either of work states as necessary, such that the display panel may display in a normal (non-confidential) manner or in a confidential manner, improving the availability of the display panel. In addition, the display panel according to the embodiment of the invention may be flexibly and conveniently switched between the non-confidential work state and the confidential work state.

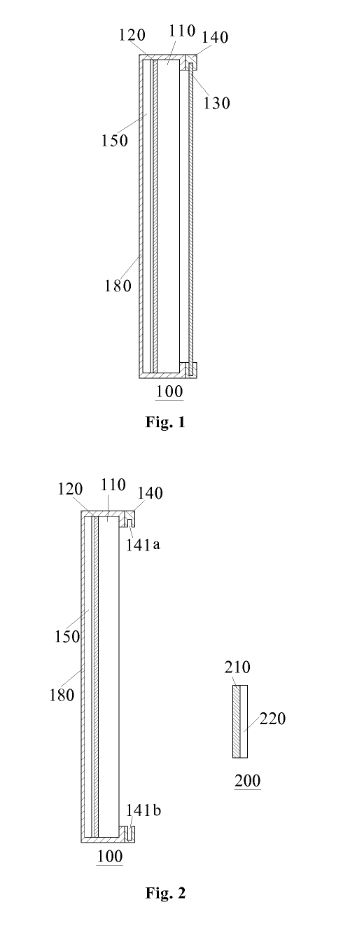

As shown in FIGS. 1-9, according to one aspect of the invention, there is provided a display panel 100 which may include: a liquid crystal cell 110, a first polarizer 120 arranged on a light inputting side of the liquid crystal cell 110 and a second polarizer 130 arranged on a light outputting side of the liquid crystal cell 110, wherein a polarization direction of the second polarizer 130 is perpendicular to a polarization direction of the first polarizer 120 and the second polarizer 130 is able to detachably cover a valid display region of the display panel 100.

When the display panel 100 operates in the non-confidential work state, the second polarizer 130 is arranged on the light outputting side of the liquid crystal cell 110 to cover the valid display region of the display panel 100 (as shown in FIGS. 1, 3, 4, 6 and 8). When it is in the non-confidential work state, everyone could see the contents displayed on the display panel from its light outputting side.

When the display panel 100 operates in the confidential work state, the second polarizer 130 is removed from the light outputting side of the display panel 100 so as not to cover the valid display region of the display panel 100 (as shown in FIGS. 2, 5, 7 and 9). The light emitted from a backlight 150 may be polarized by the first polarizer 120 to form into linearly polarized light. The linearly polarized light may enter the liquid crystal cell 110 from its light inputting side, and then exit from the liquid crystal cell 110 after conducted by liquid crystal molecules inside the liquid crystal cell 110. At this time, the light is still linearly polarized light. Without polarization detection by the second polarizer 130, the one on the light outputting side of the liquid crystal cell 110 could only see white light from the display panel, rather than the contents displayed on the display panel. In such a manner, the confidentiality on the displayed contents may be realized.

Meanwhile, in order to see the contents displayed on the display panel 100, the invention may further provide polarized glasses 200. The display panel 100 and the polarized glasses 200 constitute the display device in the invention. Further, the polarized glasses 200 may include a third polarizer 210, a polarization direction of which is perpendicular to the polarization direction of the first polarizer 120. Therefore, only when an operator on the light outputting side of the display panel 100 wears the polarized glasses 200 as shown in FIG. 2, the operator could see the contents displayed on the display panel 100. That is, other ones enter the workspace in which said display panel 100 is placed, the ones could not see the contents displayed on the display panel 100 and operate on the displayed contents without wearing the polarized glasses 200. In such a manner, the confidentiality on the displayed contents may be realized.

From above, a switch of the display panel 100 between the confidential work state and the non-confidential work state can be realized by adjusting the position of the second polarizer 120. If there are no confidential files to be processed, the display panel 100 may operate in the non-confidential work state; at this point, the second polarizer 130 covers the valid display region of the display panel. If there are confidential files to be processed, the display panel 100 may be switched to the confidential work state; at this point, the second polarizer 130 is removed from the valid display region of the display panel. Therefore, it is possible to effectively improve the availability of the display panel 100 and the display device having said display panel 100, and to provide a confidentiality effect on files in a convenient manner.

In the invention, various methods could be used to realize the removable coverage of the valid display region of the display panel 100 by the second polarizer 130. In the embodiment as shown in FIGS. 1 and 2, the display panel 100 may include a first fixing component 140 provided on the light outputting side of the liquid crystal cell 110. The second polarizer 130 may be detachably arranged to the first fixing component 140.

As shown in FIG. 1, when the display panel 100 is in the non-confidential work state, the second polarizer 130 on the light outputting side of the liquid crystal cell 110 is arranged to the first fixing component 140 to cover the valid display region of the display panel 100.

As shown in FIG. 2, when the display panel 100 is in the confidential work state, the second polarizer 130 is detached from the first fixing component 140, such that the second polarizer 130 does not cover the valid display region of the display panel 100.

In this embodiment, there is no special requirement on specific structure of the first fixing component 140. For example, the first fixing component 140 may be a bracket on which the second polarizer 130 is supported.

In this embodiment, as shown in FIGS. 1 and 2, the first fixing component 140 is provided on opposite sides of the valid display region of the display panel 100 (for example, upper and lower sides). Slots 141a and 141b may be provided on the first fixing component 140 on the opposite sides of the valid display region. Herein, the slots 141a and 141b may be extended along an entire length of the first fixing component 140. The slots 141a and 141b may be opened toward each other such that the slots 141a and 141b are able to receive opposite side edges of the second polarizer 130. In such a manner, the slots 141a and 141b of the first fixing component 140 may be used to retain the second polarizer 130 on the light outputting side of the liquid crystal cell 110. Although the slots 141a and 141b of the first fixing component 140 as shown in Figures are provided on the upper and lower sides of the display panel 100, it should be understood that the slots 141a and 141b of the first fixing component 140 may be positioned on right and left sides of the display panel 100.

It should be readily understood, an area of the second polarizer 130 is larger than or equal to that of the valid display region of the display panel, in such a manner that when the second polarizer 130 is mounted in the slots 141a and 141b, the second polarizer 130 may completely cover the valid display region of said display panel.

As an alternative, one side of the second polarizer 130 may be hinged to a frame 180 of the display panel 100 by a hinge 160.

For example, the second polarizer 130 may be also removably arranged on the light outputting side of display panel 100 by the hinge. Therefore, the second polarizer 130 may be pivoted about the hinge 160, such that the second polarizer 130 may cover the valid display region of the display panel 100 or be removed from the valid display region of the display panel 100.

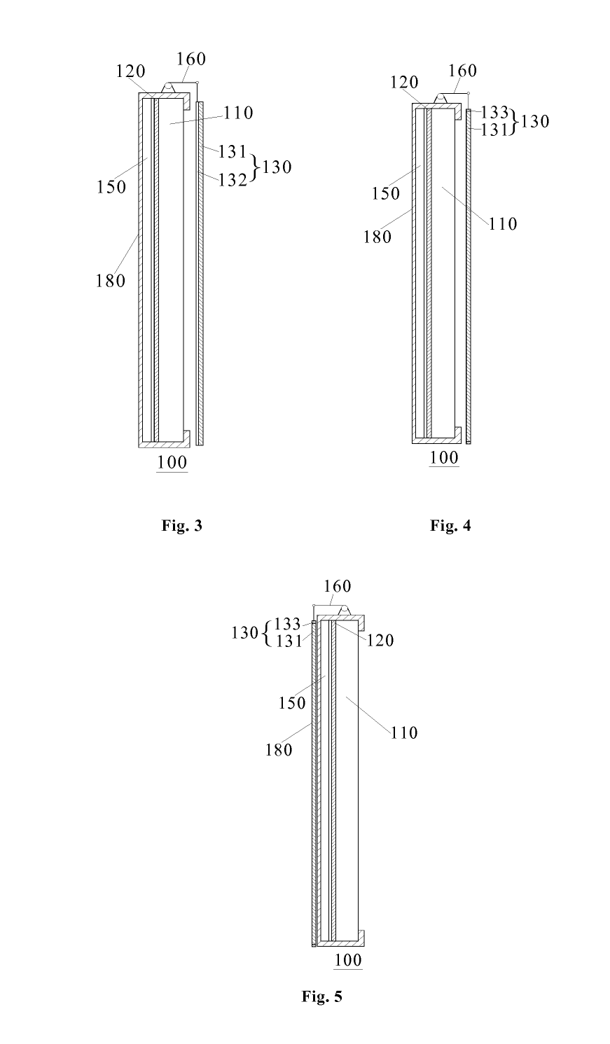

In the embodiment as shown in FIGS. 3-5, the second polarizer 130 may be pivoted from a display side of the display panel 100 to a non-display side of the display panel 100 (namely, a rear side of the display panel 100) by the hinge 160. As shown in FIGS. 3 and 4, when the display panel 100 is in the non-confidential work state, the second polarizer 130 covers the valid display region of the display panel 100; as shown in FIG. 5, when the display panel 100 is in the confidential work state, the second polarizer 130 is pivoted to the rear side of the display panel 100 by the hinge 160.

In order to pivot the second polarizer 130 from the display side of the display panel 100 to the non-display side of the display panel 100, the hinge 160 may be provided on the frame 180 of the display panel 100 on an upper side, or the hinge 160 may be provided on the frame of the display panel 100 on a left side, or the hinge 160 may be provided on the frame of the display panel 100 on a right side.

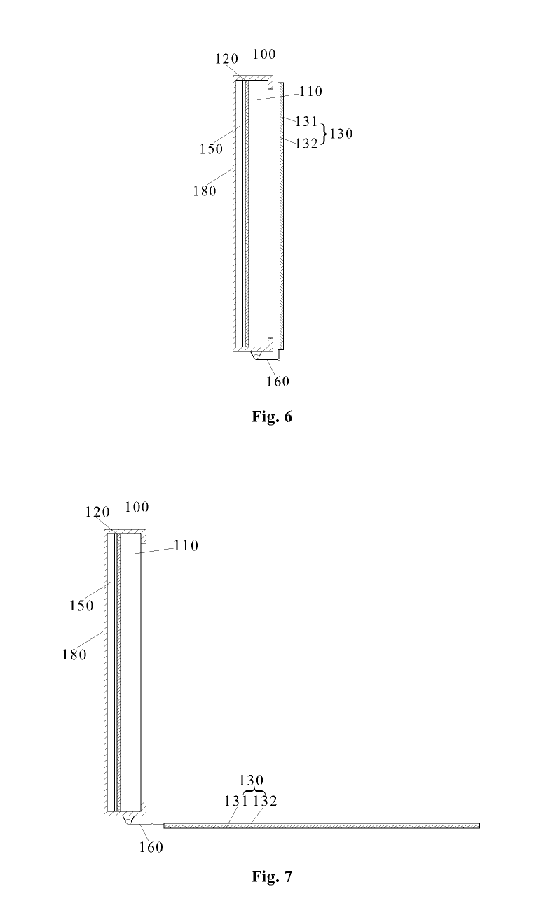

As a matter of course, in the invention, the hinge 160 may be also arranged on the frame 180 of the display panel 100 on a lower side. As shown in FIGS. 6 and 7, when the display panel 100 is in the confidential work state, the second polarizer 130 may be pivoted downward to be supported on a desk.

Optionally, in order to prevent deformation or damage of the second polarizer 130 in use or during pivoting, as shown in FIG. 3, the second polarizer 130 may include a polarization element 131 and a transparent base 132. The polarization element 131 is attached to the transparent base 132. Herein, a polarization direction of the polarization element 131 is perpendicular to a polarization direction of the first polarizer 120, and the transparent base 132 has no polarization. In the case where the second polarizer 130 includes the polarization element 131 and the transparent base 132, the transparent base 132 may be hinged to the frame 180 of the display panel 100. The transparent base 132 may be formed of a glass substrate or a plastic substrate, while the polarization element 131 may be made of a high molecular material. Since the second polarizer 130 includes the transparent base 132, it is possible to improve an overall stiffness of the second polarizer 130, so as to make the second polarizer 130 easily pivot and to increase service life.

As an alternative, optionally, in order to prevent deformation or damage of the second polarizer 130 in use or during pivoting, as shown in FIG. 4, the second polarizer 130 may include a polarization element 131 and a polarization element frame 133. The polarization element frame 133 is provided to surround an edge of the polarization element 131, or is only provided on opposite sides of the polarization element 131. The polarization direction of the polarization element 131 is perpendicular to the polarization direction of the first polarizer 120. In the case where the second polarizer 130 includes the polarization element 131 and the polarization element frame 133, the polarization element frame 133 is hinged to the frame 180 of the display panel 100.

When the display panel 100 is in the non-confidential work state, optionally, in order to fix the second polarizer 130 with respect to the display panel 100, a second fixing component (not shown) may be provided on the frame 180 of the display panel 100. The second fixing component may be arranged on a side of the frame 180 opposite to the hinge 160. The second fixing component may be used to fix the second polarizer 130 on the light outputting side of the liquid crystal cell. In invention, there is no limitation to specific structure of the second fixing component. For example, the second fixing component may be snaps. Or, the second fixing component may be sucking pieces such as a sucking disk, a magnet and the like. In the case where the second polarizer 130 includes the transparent base, the second fixing component may be a sucking disk. When the second polarizer is placed on the display side of the display panel, the transparent base may be pressed against the second fixing component, such that the second fixing component is attracted to the transparent base. Or, in the case where the second polarizer 130 includes the polarization element frame which is made of a magnetic material, the second fixing component may be a magnet. When the second polarizer is placed on the display side of the display panel, the second fixing component may attract the polarization element frame to fix the second polarizer. Of course, a fixing element may be also provided on the non-display side (namely, rear side) of the display panel, such that the second polarizer may be fixed on the non-display side of the display panel.

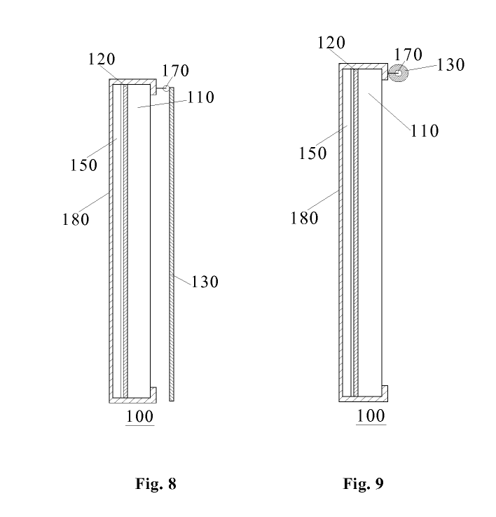

As an alternative, as shown in FIGS. 8 and 9, the second polarizer 130 may be made of a flexible material, and the display panel 100 may include a reel 170. The reel 170 is arranged on the side of the valid display region of the display panel 100. For example, the reel 170 may be arranged on the frame of the display panel 100 on a left side or on a right side or on a upper side or on a lower side, so as not to shield the valid display region of the display panel 100. The second polarizer 130 is fixedly connected to the reel 170 at one end, so as to be wound around the reel 170.

As shown in FIG. 8, when the display panel is in the non-confidential work state, the second polarizer 130 is unwound to cover the valid display region of the display panel 100; as shown in FIG. 9, when the display panel is in the confidential work state, the second polarizer 130 may be wound around the reel 170 so as not to cover the valid display region of the display panel 100 any more.

According to another aspect of the invention, there is provided a display device. As shown in FIG. 2, the display device may include the display panel 100 and polarized glasses 200, wherein the display panel 100 is the display panel of the invention as described above, and the polarized glasses 200 may include a third polarizer 210, a polarization direction of which is perpendicular to a polarization direction of the first polarizer 120.

From above, when the display panel 100 of the display device is in the non-confidential work state, the second polarizer 130 covers the valid display region of the display panel 100, such that there is no need to wear the polarized glasses 200 to see the displayed contents; when the display panel 100 of the display device is in the confidential work state, the second polarizer 130 is removed from the valid display region of the display panel 100, such that it is required to use the display panel 100 cooperating with the polarized glasses 200 to see the displayed contents. That is, only when an operator wears the polarized glasses 200, he or she could see the contents displayed on the display panel 100.

The display device according to the embodiment of the invention may be switched between the confidential work state and the non-confidential work state, whereby improving the availability thereof.

In the invention, there is no special requirement on specific structure of the polarized glasses 200. For example, the third polarizer 210 may be directly used to make lenses of the polarized glasses 200. Or, optionally, in order to prevent deformation of the lenses of the polarized glasses 200 and improve comfort level of a wearer in use, the polarized glasses 200 may include rigid substrate lenses 220, to which the third polarizer 210 is attached. In addition, the substrate lenses 220 may be processed to have a certain dioptre to facilitate various groups of people to use said polarized glasses.

It should be understood that the above embodiments are merely exemplary embodiments for the purpose of illustrating the principle of the invention, and the invention is not limited thereto. Various modifications and improvements can be made by a person having ordinary skill in the art without departing from the spirit and the essence of the invention. Accordingly, all of the modifications and improvements also fall into the protection scope of the invention.

1. A display panel, including:
a liquid crystal cell;
a first polarizer, arranged on a light inputting side of the liquid crystal cell; and
a second polarizer, a polarization direction of which is perpendicular to a polarization direction of the first polarizer,
wherein the second polarizer is detachably arranged on a light outputting side of the liquid crystal cell and is able to cover a valid display region of the display panel.

2. The display panel according to claim 1, wherein said display panel includes a first fixing component arranged on the light outputting side of said liquid crystal cell, said second polarizer being detachably attached to the display panel by said first fixing component.

3. The display panel according to claim 2, wherein said first fixing component is arranged on opposite sides of the valid display region of said display panel, slots are formed in said first fixing component on the opposite sides of the valid display region, and said slots are opened toward each other such that said slots are able to receive opposite side edges of said second polarizer.

4. The display panel according to claim 1, wherein one side of said second polarizer is hinged to a frame of said display panel by a hinge.

5. The display panel according to claim 4, wherein said second polarizer is able to be pivoted from a display side of said display panel to a non-display side of said display panel by said hinge.

6. The display panel according to claim 4, wherein said second polarizer includes a polarization element and a transparent base, said polarization element being attached to said transparent base, a polarization direction of said polarization element being perpendicular to a polarization direction of said first polarizer, and said transparent base being hinged to the frame of said display panel.

7. The display panel according to claim 5, wherein said second polarizer includes a polarization element and a transparent base, said polarization element being attached to said transparent base, a polarization direction of said polarization element being perpendicular to a polarization direction of said first polarizer, and said transparent base being hinged to the frame of said display panel.

8. The display panel according to claim 4, wherein said second polarizer includes a polarization element and a polarization element frame surrounding an edge of said polarization element, a polarization direction of said polarization element being perpendicular to a polarization direction of said first polarizer, and said polarization element frame being hinged to the frame of said display panel.

9. The display panel according to claim 5, wherein said second polarizer includes a polarization element and a polarization element frame surrounding an edge of said polarization element, a polarization direction of said polarization element being perpendicular to a polarization direction of said first polarizer, and said polarization element frame being pivoted to the frame of said display panel.

10. The display panel according to claim 4, wherein a second fixing component is provided on the frame of said display panel, said second fixing component being arranged on a side of the frame opposite the hinge to fix said second polarizer on the light outputting side of said liquid crystal cell of said display panel.

11. The display panel according to claim 5, wherein a second fixing component is provided on the frame of said display panel, said second fixing component being arranged on a side of the frame opposite the hinge to fix said second polarizer on the light outputting side of said liquid crystal cell of said display panel.

12. The display panel according to claim 1, wherein said display panel includes a reel which is arranged on the side of the valid display region of said display panel, said second polarizer being fixedly connected to the reel at one end and being able to be wound around the reel.

13. A display device, comprising a display panel and polarized glasses, wherein said display panel is the display panel according to claim 1, and said polarized glasses includes a third polarizer, a polarization direction of which is perpendicular to the polarization direction of said first polarizer.

14. The display device according to claim 13, wherein said display panel includes a first fixing component arranged on the light outputting side of said liquid crystal cell, said second polarizer being detachably attached to the display panel by said first fixing component.

15. The display device according to claim 14, wherein said first fixing component is arranged on opposite sides of the valid display region of said display panel, slots are formed in said first fixing component on the opposite sides of the valid display region, and said slots are opened toward each other such that said slots are able to receive opposite side edges of said second polarizer.

16. The display device according to claim 13, wherein one side of said second polarizer is hinged to a frame of said display panel by a hinge.

17. The display device according to claim 16, wherein said second polarizer is able to be pivoted from a display side of said display panel to a non-display side of said display panel by said hinge.

18. The display device according to claim 16, wherein said second polarizer includes a polarization element and a transparent base, said polarization element being attached to said transparent base, a polarization direction of said polarization element being perpendicular to a polarization direction of said first polarizer, and said transparent base being hinged to the frame of said display panel.

19. The display device according to claim 16, wherein said second polarizer includes a polarization element and a polarization element frame surrounding an edge of said polarization element, a polarization direction of said polarization element being perpendicular to a polarization direction of said first polarizer, and said polarization element frame being hinged to the frame of said display panel.

20. The display device according to claim 13, wherein said display panel includes a reel which is arranged on the side of the valid display region of said display panel, said second polarizer being fixedly connected to the reel at one end and being able to be wound around the reel.
